(19) United States
(12) Patent Application Publication
(10) Pub. No.: US 2006/0230089 A1
(43) Pub. Date: Oct. 12, 2006

(54) Frequency estimation

(76) Inventors: Ian Russell Scott, Christchurch (NZ); Refik Shadich, Christchurch (NZ); William Mark Siddall, Christchurch (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/546,696

(22) PCT Filed: Feb. 24, 2004
(86) PCT No.: PCT/NZ04/00035

§ 371 Date: Jun. 5, 2006

(30) Foreign Application Priority Data
Feb. 24, 2003 (NZ) 524369

(51) Int. Cl. G06F 1/02

(52) U.S. Cl. 708/270

(57) ABSTRACT

The present invention relates to a method and hardware for estimating the frequency offset of a signal. The method includes obtaining samples of the signal at at least two instants in time, and utilising the samples in a mathematical equation relating estimated offset frequency to the samples, wherein the mathematical equation is derived based on the premise of a modulating signal with a complex frequency.

### FIELD OF THE INVENTION

The present invention relates to a method and/or apparatus for estimating the instantaneous frequency offset of a signal from a nominal frequency. The invention can be applied to provide methods and/or apparatus for FM demodulation, FM modulation, frequency synthesis, and signal estimation in test equipment, for example.

### BACKGROUND TO THE INVENTION

In telecommunications, and other areas of technology also, it is often necessary to obtain the frequency offset of a signal from a nominal frequency by some type of signal processing method. For example, frequency offset estimation is a key process in carrying out FM demodulation/modulation, frequency synthesis and signal estimation in test equipment.

Modulation refers to the process of adapting a given signal to suit a given communication channel and Demodulation refers to the inverse process of signal extraction from the channel. Typical modulation schemes include AM, SSB, FM, FSK, MSK, PSK, QPSK and QAM for both wired, radio and optical channels.

Each scheme has relative merits and weaknesses depending on application. High order QAM, for example has the best spectral efficiency for a given data throughput, but requires complex implementation and does not cope well with time variable channels. At the other extreme AM is perhaps the simplest scheme to implement but is wasteful of power and spectral efficiency.

A modulated frequency offset can be used to convey information in a communication system. In FSK (frequency shift keying) a positive offset can represent a binary “1” and a negative offset can represent a binary “0”. In analog FM the frequency offset or “deviation” is proportional to the amplitude of the modulating signal.

As an example, carrier waves can be FM modulated with a message signal for transmission, and later, upon reception, the carrier wave can be FM demodulated to retrieve the message. A wide variety of modulation and corresponding demodulation techniques are employed, depending upon the particular application, many utilising some type of frequency offset estimation technique. For example, to demodulate a FM modulated carrier signal, it is necessary to determine how much the frequency of the modulated wave has deviated from the nominal frequency of the carrier signal. The modulation process uses frequency estimation in a more indirect manner.

Traditionally, frequency offset estimation is determined using analog techniques, or by a digital technique based on the differential of an angular phase offset estimate. The latter technique utilises an arctangent look up table and a digital filter. For example, often the following equation is used:

$$Δ f = \frac{1}{Δ t} \cdot \frac{{I}_{n} \cdot {Q}_{n - 1} - {I}_{n - 1} \cdot {Q}_{n}}{{I}_{n} \cdot {I}_{n - 1} + {Q}_{n - 1} \cdot {Q}_{n}}$$

where Δf is the frequency offset, Iₙ₋₁, Iₙ and Qₙ₋₁, Qₙ are in-phase and quadrature samples at respective instants in time, and Δt is the sample interval. Existing methods utilising this equation can produce unacceptable inaccuracies in the final frequency offset estimation, and can be undesirably complex to implement in circuitry.

### SUMMARY OF THE INVENTION

It is an object of the present invention to provide an alternative method and/or apparatus for determining instantaneous frequency offset estimation of a signal, from a nominal frequency. Mathematical relationships have been derived that can be utilised to estimate an offset frequency of a signal at an instant. The mathematical relationships can be implemented to provide more accurate frequency estimation and/or can be implemented more conveniently than existing technology.

The invention can be used in a range of applications, such as FM demodulation, FM modulation, frequency synthesis, and signal estimation in test equipment. For example, a plurality of frequency offset estimations of a signal can be obtained and used in a FM modulation process. Alternatively, a plurality of frequency offset estimations of a signal can be used to directly or indirectly FM demodulate that signal.

In broad terms in one aspect the invention comprises a method for estimating the frequency offset of a signal including: obtaining samples of the signal at at least two instants in time, and utilising the samples in a mathematical equation relating estimated offset frequency to the samples, wherein the mathematical equation is derived based on the premise of a modulating signal with a complex frequency.

The mathematical equation has a numerator term that provides FM demodulation, and a denominator that provides scaling.

In broad terms in another aspect the invention comprises hardware for estimating the frequency offset of a signal including: a sampler for obtaining samples of the signal at at least two instants in time, and processor for implementing a mathematical equation for obtaining an offset frequency estimate from samples, wherein the mathematical equation is derived based on the premise of a modulating signal with a complex frequency.

The mathematical equation has a numerator term that provides FM demodulation, and a denominator that provides scaling. The processor may be a DSP, microprocessor, FPGA or other suitable hardware.

In broad terms in another aspect the invention comprises a method for estimating the frequency offset of a signal including: sampling the signal to obtain I and Q component samples representing the signal at at least two instants in time, determining an instantaneous frequency offset estimate from the samples utilising the relationship defined by

$${ω}_{{n}^{*}} = \frac{2}{Δ t} \cdot \frac{{I}_{n - 1} \cdot {Q}_{n} - {I}_{n} \cdot {Q}_{n - 1}}{{( {I}_{n} + {I}_{n - 1} )}^{2} + {( {Q}_{n} + {Q}_{n - 1} )}^{2}}$$

or an approximation to or mathematical equivalent of the relationship, where ωₙ* is the frequency offset, Iₙ₋₁, Iₙ and Qₙ₋₁, Qₙ are I and Q samples at respective instants in time, n is the sample number and Δt is the sample interval.

A correction can be applied to the relationship to produce:

$$Δ {f}_{n}^{′} = \frac{{F}_{s}}{2 \cdot π} \cdot arctan \{ \frac{{V}_{{t}_{n - 1}} \cdot {V}_{qn} - {V}_{{t}_{n}} \cdot {V}_{{q}_{n - 1}}}{{( {V}_{{t}_{n}} + {V}_{{t}_{n - 1}} )}^{2} + {( {V}_{qn} + {V}_{qn - 1} )}^{2}} \}$$

where Δf′ₙ is the corrected estimate of frequency offset ωₙ* and Fₛ is 1/Δt. This corrected relationship can be used to produce a more accurate frequency offset estimation.

Preferably, a plurality of frequency offset estimates are determined for the signal for a plurality of instants in time.

The plurality of determined frequency offsets can be utilised in FM demodulating a signal. Alternatively, they can be utilised in FM modulating a signal with a message signal. For example, a frequency control loop (FCL) can be constructed utilising the relationship or approximation to or mathematical equivalent of the relationship. The FCL can be utilised in FM demodulation, FM modulation or frequency synthesis applications.

Preferably, the I and Q samples utilised in the mathematical relationship are samples adjacent in time.

In broad terms in another aspect the invention comprises hardware for estimating the frequency offset of a signal including: a sampler for obtaining I and Q component samples representing the signal at at least two instants in time, and a processor for determining a frequency offset from the samples utilising the relationship defined by:

$${ω}_{{n}^{*}} = \frac{2}{Δ t} \cdot \frac{{I}_{n - 1} \cdot {Q}_{n} - {I}_{n} \cdot {Q}_{n - 1}}{{( {I}_{n} + {I}_{n - 1} )}^{2} + {( {Q}_{n} + {Q}_{n - 1} )}^{2}}$$

or an approximation to or mathematical equivalent of the relationship, where ωₙ* is the frequency offset, Iₙ₋₁, Iₙ and Qₙ₋₁, Qₙ are I and Q samples at respective instants in time, n is the sample number and Δt is the sample interval.

A correction can be applied to the relationship to produce:

$$Δ {f}_{n}^{′} = \frac{{F}_{s}}{2 \cdot π} \cdot arctan \{ \frac{{V}_{{t}_{n - 1}} \cdot {V}_{qn} - {V}_{{t}_{n}} \cdot {V}_{{q}_{n - 1}}}{{( {V}_{{t}_{n}} + {V}_{{t}_{n - 1}} )}^{2} + {( {V}_{qn} + {V}_{qn - 1} )}^{2}} \}$$

where Δf′ₙ is the corrected estimate of frequency offset ωₙ* and Fₛ is 1/Δt. This corrected relationship can be used to produce a more accurate frequency offset estimation.

The processor may be a DSP, microprocessor, FPGA or other suitable hardware. Preferably, the hardware is adapted to determine a plurality of frequency offset estimates for the signal for a plurality of instants in time.

The hardware can be utilised to produce a FM demodulator. Alternatively, the hardware can be utilised to produce a FM modulator. For example, a frequency control loop (FCL) can be constructed utilising the mathematical relationship of the invention. The FCL can then be utilised in FM demodulation, FM modulation or frequency synthesis applications. Preferably, the I and Q samples obtained for calculating the mathematical relationship are samples adjacent in time.

In broad terms in another aspect the invention comprises a frequency control loop for use in a FM modulator or demodulator, including: hardware for mixing signals from a frequency source and a VCO, a processor for implementing a frequency offset estimation method according to the invention, and an integrator for generating an error control signal for the VCO.

### BRIEF LIST OF FIGURES

Preferred embodiments of the invention will be described with reference to the following drawings, of which:

FIG. 1 is a block diagram of an implementation for carrying out instantaneous frequency offset estimation according to the invention;

FIG. 2 is a block diagram of an implementation of the demodulator in FIG. 1;

FIG. 3 shows an instantaneous discrete time samples complex frequency step;

FIG. 4 shows a conventional FM receiver mute architecture;

FIG. 5 shows an FM receiver mute architecture using the frequency offset estimation of the invention;

FIG. 6 shows a complex frequency modulator, and

FIG. 7 shows a complex frequency demodulator.

### DETAIL DESCRIPTION OF THE PREFERRED EMBODIMENTS

Referring to the drawings it will be appreciated that the frequency offset estimation equations according to the invention can be implemented in a range of applications. The following examples relating to FM modulation and demodulation are given by way of example only, and should not be considered exhaustive of the possible areas of application. The skilled person will understand how to implement the invention in a range of other applications. Further it will be appreciated that other representations, mathematical equivalents, and/or approximations of the equations stated could also be used. It is not intended that the invention be limited to just the form of the equations shown. Rather the invention relates to the frequency estimation concept embodied in those equations.

An FM signal received by an FM receiver has the form:
Vᵣₜ{t}=k cos(2π(F_{RF}+dF)t+A{t}+B)
where A{t} represents the phase of the modulation, F_{RF} represents the carrier frequency, k is the amplitude of the received signal, B is the arbitrary phase, and dF is a static offset error.

The phase of the modulation A{t} is related to the frequency deviation by
A{t}=∫ω(t)
where ω(t)=2πf{t} and ω(t) is the modulating frequency in radians, and f is the modulating frequency. The demodulate the FM signal is to find the modulating frequency ω(t).

This is a conventional representation at RF, however modern receiver approaches attempt to strip the carrier away, as it conveys no information in itself (information is relative to the carrier). The I+jQ representation of the signal is a represent centred at DC and has positive and negative frequency components (positive being above carrier and negative being below the carrier).

The initial hardware processing translates the RF signal into I and Q components, which contain the information (FM, FSK, QPSK, PSK, QAM, OFDM etc can all be represented as I and Q vectors). This initial processing is well known to those skilled in the art. The demodulation task is to interpret this new signal representation in order to extract information.

In I and Q format the signal can be written as:
V_{iq}{t}=k exp^{jB} exp^{j(2πdFt+A{t}}
ie the carrier frequency term F_{RF} disappears. The demodulation task is to extract A{t} and then ω(t) from V_{iq}{t} despite k, B, and dF.

A preferred embodiment of the invention relates to a method of estimating an instantaneous offset frequency of signal from a nominal frequency. The method is implemented using the relationship:

$${ω}_{{n}^{*}} = \frac{2}{Δ t} \cdot \frac{{I}_{n - 1} \cdot {Q}_{n} - {I}_{n} \cdot {Q}_{n - 1}}{{( {I}_{n} + {I}_{n - 1} )}^{2} + {( {Q}_{n} + {Q}_{n - 1} )}^{2}}$$

where ωₙ* is the instantaneous frequency offset from the nominal frequency, Iₙ₋₁, Iₙ, Qₙ₋₁, Qₙ are I and Q samples of the signal at respective instants in time, n is the sample number, and Δt is the sample interval.

For example, the signal may be a carrier wave FM modulated with a message signal. The frequency offset, ωₙ*, from the carrier wave frequency due to the FM modulation is determined using the above relationship from I and Q samples of the modulated carrier wave. As will be described, the equation is derived from the premise that the modulating signal has a complex frequency, rather than just a real frequency.

The above equation shows the mathematical relationship between the in-phase and quadrature components of the received signal (in the I+jQ representation) and the instantaneous frequency offset, which embodies the frequency estimation technique. However it will be appreciated that the relationship may be implemented by using a mathematically equivalent equation represented in an alternative manner. Approximations of the implementation may also be utilised. The above equation provides a mathematical definition of the relationship, but should not be construed as necessarily being the only form in which the relationship can be implemented.

The above equation can be adapted to correct for errors brought in by the sampling process, resulting in:

$$Δ {f}_{n}^{′} = \frac{{F}_{s}}{2 \cdot π} \cdot arctan \{ \frac{{V}_{{t}_{n - 1}} \cdot {V}_{qn} - {V}_{{t}_{n}} \cdot {V}_{{q}_{n - 1}}}{{( {V}_{{t}_{n}} + {V}_{{t}_{n - 1}} )}^{2} + {( {V}_{qn} + {V}_{qn - 1} )}^{2}} \}$$

where Δf′ₙ is the corrected estimate of frequency offset ωₙ* and Fₛ is 1/Δt. This corrected relationship can be used to produce a more accurate frequency offset estimation.

The method according to the invention can used in a range of applications in which frequency offsets are required, to replace existing methods used to obtain the frequency offsets. For example, the method can be implemented to obtain frequency offsets for FM demodulation, FM modulation, frequency synthesis, or signal estimation in test equipment. One particular implementation is in a frequency control loop such as that disclosed in the applicant's patent application NZ524537. Other applications are also possible. The method may be implemented in any hardware, such as a DSP, microprocessor, FPGA or the like, as suitable for the particular application.

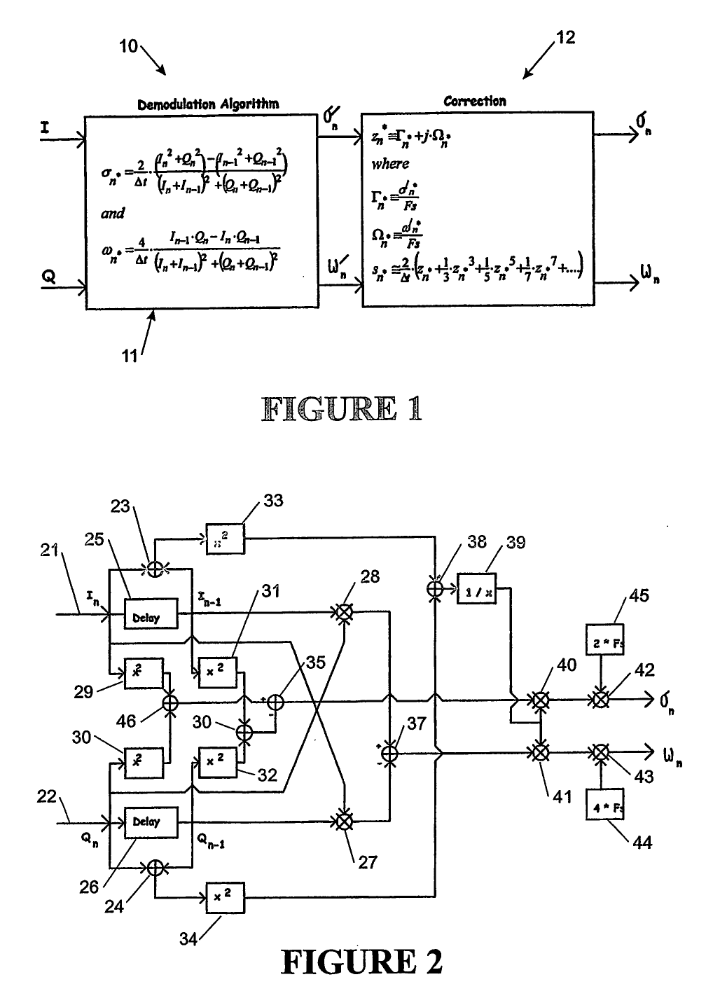

A preferred embodiment of a frequency estimator 10 according to the invention is shown in FIG. 1. This embodiment could be implemented in analog or digital, although more preferably in digital using a DSP or similar. The estimator 10 includes I and Q inputs for quadrature components of an input signal. The I and Q components are processed in a demodulator 11 which calculates or otherwise determines estimates of real and imaginary components, jωₙ* and σₙ*, of the frequency offset of the signal according to

$${ω}_{{n}^{*}} = \frac{2}{Δ t} \cdot \frac{{I}_{n - 1} \cdot {Q}_{n} - {I}_{n} \cdot {Q}_{n - 1}}{{( {I}_{n} + {I}_{n - 1} )}^{2} + {( {Q}_{n} + {Q}_{n - 1} )}^{2}} .$$

The initial real and imaginary estimates are passed to a corrector 12 which implements the correction algorithm specified by

$$Δ {f}_{n}^{′} = \frac{{F}_{s}}{2 \cdot π} \cdot arctan \{ \frac{{V}_{{t}_{n - 1}} \cdot {V}_{qn} - {V}_{{t}_{n}} \cdot {V}_{{q}_{n - 1}}}{{( {V}_{{t}_{n}} + {V}_{{t}_{n - 1}} )}^{2} + {( {V}_{qn} + {V}_{qn - 1} )}^{2}} \} ,$$

to produced corrected real and imaginary estimates jω and σ. These outputs can then be used as required in the end application, such as a frequency control loop, FM demodulator or modulator, or the like.

FIG. 2 shows a block diagram representation of the demodulator 11, which can be implemented in a suitable technology known to those skilled in the art.

As can be seen in FIG. 2 the sampled in-phase and quadrature signals Iₙ, and Qₙ are supplied to the demodulator at 21 and 22. The in-phase signal is then provided to adder 23, unit delay 25, multiplier 27 and squarer 29. The quadrature signal is provided to adder 24, unit delay 26, multiplier 28 and squarer 30. The function of the unit delay is to provide the previous sample as the output. Thus the output of delay 25 is Iₙ₋₁ and the output of delay 26 is Qₙ₋₁. The output of delay 25 is provided to adder 23, squarer 31 and multiplier 28. The output of delay 26 is provided to adder 24, squarer 32 and multiplier 27.

At adder 23 the I sample and the delayed I sample are added to produce the result Iₙ+Iₙ₋₁. This is then squared in squarer 33 to produce (Iₙ+Iₙ₋₁)². The output of the squarer is provided to adder 38. At adder 24 the Q sample and the delayed Q sample are added to produce the result Qₙ+Qₙ₋₁. This is then squared in squarer 34 to produce (Qₙ+Qₙ₋₁)². The output of the squarer is provided to adder 38. At adder 38 the outputs of squarers 33 and 34 are summed to produce (Iₙ+Iₙ₋₁)²+(Qₙ+Qₙ₋₁)². This is the denominator for both the real and imaginary parts of the instantaneous frequency offset. The result of adder 38 is provided to inverter 39 to form the denominator for σₙ* and ωₙ*.

At multiplier 28 the delayed in-phase signal is multiplied by the quadrature signal to produce Iₙ₋₁Qₙ. At multiplier 27 the delayed quadrature signal is multiplied by the in-phase signal to produce IₙQₙ₋₁. The output of multiplier 27 is subtracted from the output of multiplier 28 at adder 37 to produce Iₙ₋₁Qₙ−IₙQₙ₋₁. This is then multiplied by the output of inverter 39 at multiplier 41 to produce

$$\frac{{I}_{n - 1} {Q}_{n} - {I}_{n} {Q}_{n - 1}}{{( {I}_{n} + {I}_{n - 1} )}^{2} + {( {Q}_{n} + {Q}_{n - 1} )}^{2}}$$

This is then multiplied by 4Fₛ (where Fₛ is the sampling frequency) at multiplier 43 to produce the imaginary part of the instantaneous frequency offset.

At adder 46 the squared in-phase signal is added to the squared quadrature signal to produce Iₙ²+Qₙ². As squarer 32 the delayed quadrature signal is squared to produce Qₙ₋₁². At squarer 31 the delayed in-phase signal is squared to produce Iₙ₋₁². At adder 36 the squared delayed in-phase and quadrature signals are added to produce Iₙ₋₁²+Qₙ₋₁². This is then subtracted from the output of adder 46 at adder 35 to produce Iₙ²+Qₙ²−(Iₙ₋₁²+Qₙ₋₁²). This forms the numerator of the real part of the instantaneous frequency offset. This is multiplied by the denominator at multiplier 40 to produce

$$\frac{( {I}_{n}^{2} + {Q}_{n}^{2} ) - ( {I}_{n - 1}^{2} + {Q}_{n - 1}^{2} )}{{( {I}_{n} + {I}_{n - 1} )}^{2} + {( {Q}_{n} + {Q}_{n - 1} )}^{2}}$$

This is then multiplied by 2Fₛ at multiplier 42 to produce the imaginary part of the instantaneous frequency offset.

FIG. 2 provides only one illustration of the demodulator 11 of FIG. 1. It should be noted that other formations of demodulator 11 could also be used. Demodulator 11 as illustrated in FIG. 2 could be implemented in software or hardware or a combination of software or hardware. The software and/or hardware for implementing demodulator 11 could be a DSP, microprocessor, FPGA or any other suitable hardware. In preferred embodiments the software/hardware is arranged to determine a plurality of frequency offset estimates for the signal at a plurality of instants of time. Mathematically equivalent or alternative forms of the frequency estimation equation including the corrected frequency estimation equation could also be implemented in hardware.

In one embodiment the modulator or demodulator of FIG. 2 is implemented in a frequency control loop. The frequency control loop includes a mixer for mixing signals from a frequency source and a voltage controlled oscillator (VCO), a processor for implementing the modulator or demodulator of FIG. 2 and an integrator. The integrator generates an error control signal for the VCO. The output of the VCO changes in response to changes in the error control signal. The frequency control loop provides a frequency adjustable output signal that is kept stable through a feedback arrangement. The frequency control loop may be part of an FM modulator or an FM demodulator. One particular example of frequency control loop that may use the frequency offset estimator of the invention is given in the Applicant's New Zealand patent application 524537.

Conventional FM involves the use of an initial carrier frequency that is perturbed by a modulating signal prior to transmission. The perturbations are demodulated in the receiver and the signal is recovered. As the carrier frequency varies with the modulation its phase also varies according to the relationship

$$δω \{ t \} ≡ \frac{\partial }{\partial t} θ \{ t \} \\ for \\ V \{ t \} ≡ A \cdot cos \{ ( {ω}_{RF} + δω \{ t \} ) \cdot t + ϕ \} \qquad ( 1 )$$

where V{t} is the received baseband signal, A is the amplitude of the signal, ω_{RF} is the carrier frequency, and φ is the arbitrary phase term.

The signal can also be represented in Complex Baseband format which is then “up-converted” in frequency by a modulating Complex Exponential,

$$V \{ t \} ≡ \frac{A}{\sqrt{2}} \cdot Re \{ {ⅇ}^{j \cdot {ω}_{RF} \cdot t} \cdot {ⅇ}^{j \cdot θ \{ t \}} \} \qquad ( 2 )$$

where θ{t} is the modulating term.

The second formula is more convenient as the details associated with the exact carrier frequency and amplitude are independent from the modulating term V_{iq}{t}≡e^{j·θ{t}}. In conventional analysis the angular term θ{t} is assumed to be real but there is no mathematical or physical requirement for this. We will consider the more general description s{t}≡σ{t}+j·ω{t} where s{t} is a complex frequency time domain signal.

Using a complex frequency modulation theory a Non Linear Mapping (NLM) between the complex variable s{t} and its corresponding complex baseband signal can be defined as,

$${V}_{iq} \{ t \} ≡ k \cdot {ⅇ}^{{\int }_{t = {t}_{0}}^{t} s \{ τ \} \partial τ} \qquad ( 3 )$$

where k is a constant representing the amplitude of the modulation.

Equation 3 represents the proposed non linear transform from a hypothetical function s{t} and its corresponding complex baseband signal V_{iq}{t}. Equation 3 represents modulation. To illustrate demodulation s{t} must be made the subject of the equation.

Making s{τ} the subject reveals,

$$s \{ t \} = \frac{\partial }{\partial t} ln \{ \frac{1}{k} \cdot {V}_{iq} \{ t \} \} \\ i . e . \\ s \{ t \} = \frac{{\dot{V}}_{iq} \{ t \}}{{V}_{iq} \{ t \}} \qquad ( 4 )$$

where the “dot” refers to differentiation with respect to time. Alternatively s{τ} can be expressed as

$$s \{ t \} = \frac{\partial }{\partial t} ( ln \{ \vert {V}_{iq} \{ t \} \vert \} + j \cdot {θ}_{iq} \{ t \} ) \\ i . e . \\ s \{ t \} = σ \{ t \} + j \cdot ω \{ t \} \\ where \\ σ \{ t \} ≡ \frac{r \{ \dot{t} \}}{r \{ t \}} \\ and ω \{ t \} ≡ {\mathring{θ}}_{iq} \{ t \} \qquad ( 5 )$$

The instantaneous frequency deviation from the carrier frequency is represented by ω{t} and σ{t} represents a form of non-linear amplitude modulation that has identical demodulation properties to ω{t} and with r{t}≡|V_{iq}{t}| for notational clarity. Sigma (σ{t}) can be considered as the differential of an AM signal with respect to time, divided by that AM signal.

Sigma can be used for modulation and demodulation, and can also be used for FM SNR or SINAD estimation, i.e. mute operation.

Combining equations (4) and (5) now demonstrates that

$$\frac{{\dot{V}}_{iq} \{ t \}}{{V}_{iq} \{ t \}} = σ \{ t \} + j \cdot ω \{ t \} \qquad ( 6 )$$

Equations (3), (4) and (6) now allow conversion between Complex Baseband and Complex Frequency signal representations. Equation (2) describes complex frequency modulation, whilst equations (4) and (6) describe complex frequency demodulation. Equation (6) additionally explains the meaning of s{t}, whose real component σ{t} is an amplitude effect, and whose imaginary component ω{t} is a frequency offset effect.

The complex equations can be converted into real variables. Recall from equation (4)

$$s \{ t \} = \frac{{\dot{V}}_{iq} \{ t \}}{{V}_{iq} \{ t \}}$$

To simplify the notation the I and Q naming convention can be used and dropping the time variable t for convenience gives,

$$s \{ t \} = \frac{\mathring{I} + j \cdot \mathring{Q}}{I + j \cdot Q} \qquad ( 7 )$$

This can be rewritten as

$$s \{ t \} = \frac{\mathring{I} + j \cdot \mathring{Q}}{I + j \cdot Q} \cdot \frac{I - j \cdot Q}{I - j \cdot Q}$$

$$i . e . s \{ t \} = \frac{\mathring{I} \cdot I + \mathring{Q} \cdot Q}{{I}^{2} + {Q}^{2}} + j \cdot \frac{I \cdot \mathring{Q} - \mathring{I} \cdot Q}{{I}^{2} + {Q}^{2}}$$

In other words,

$$σ \{ t \} = \frac{\dot{I} \cdot I + \dot{Q} \cdot Q}{{I}^{2} + {Q}^{2}} \\ and \\ ω \{ t \} = \frac{I \cdot \dot{Q} - \dot{I} \cdot Q}{{I}^{2} + {Q}^{2}} \qquad ( 9 )$$

The real component can also be derived from equation (5), using r{t}≡(I²+Q²)^{1/2}

The previous equations are useful for system analysis and allow the effect of errors to be quantified on frequency modulation performance. For example the effect of noise, distortion, DC IQ offset, IQ gain imbalance and IQ phase skew errors can be readily calculated. This is less feasible with conventional representations based on differential of arctangent functions etc.

Modulation refers to the creation of a complex baseband signal V_{iq}{t} from a modulating complex frequency time domain signal s{t}. From equation (3)

$${V}_{iq} \{ t \} ≡ k \cdot {ⅇ}^{{\int }_{t = {t}_{0}}^{t} s \{ t \} \partial τ}$$

the continuous integral can be replaced with a simple Riemann summation, i.e.

$${V}_{{iq}_{{n}^{*}}} ≅ k \cdot {ⅇ}^{{\sum }_{n} {s}_{n} \cdot Δ t} \qquad ( 10 )$$

where the n* most correctly can be considered to be the complex baseband signal estimate that would exist somewhere between the n−1 and n-th sample and k is the amplitude of the signal. An alternative form of his equation is,

$${V}_{{iq}_{{n}^{*}}} ≅ k \cdot {\prod }_{n} {ⅇ}^{{s}_{n} \cdot Δ t} \\ however {Viq}_{n - {1}^{*}} = k \cdot {\prod }_{n - 1} {ⅇ}^{{s}_{n} \cdot Δ t} \\ ⇒ {Viq}_{{n}^{*}} = {Viq}_{n - {1}^{*}} \cdot {ⅇ}^{{s}_{n} \cdot Δ t} \qquad ( 11 )$$

Equation (11) represents an incremental modulation algorithm that uses past history multiplied by an exponential containing the current modulation sample to produce the current value of the modulating term. Unlike equation (10) equation (11) does not require a phase wrap function (to prevent the summation from becoming impractically large), but it can suffer from amplitude drift caused by cumulative rounding errors.

Complex Frequency Modulation and Demodulation is often performed digitally so some modification is required from the continuous time domain to the discrete time sampled domain.

Consider a simple approximation to the differential based on finite difference,

$$\frac{\partial }{\partial t} v \{ t \} ≅ \frac{{v}_{n} - {v}_{n - 1}}{Δ t} \qquad ( 12 )$$

and use the average estimate of v to be the best approximation relative to the differential estimate

$$\overline{v} \{ t \} ≡ \frac{{v}_{n} + {v}_{n - 1}}{2} \qquad ( 13 )$$

Equation (7) will then have its discrete time equivalent given by,

$${s}_{{n}^{*}} ≡ \frac{2}{Δ t} \cdot \frac{{V}_{{iq}_{n}} - {V}_{{iq}_{n - 1}}}{{V}_{{iq}_{n}} + {V}_{{iq}_{n - 1}}} \\ where \\ {s}_{{n}^{*}} ≡ {σ}_{{n}^{*}} + j \cdot {ω}_{{n}^{*}} \qquad ( 14 )$$

where sₙ* σₙ* and ωₙ* represent frequency offset estimates approximated between (n−1)^{th} and n^{th} samples.

Writing V_{iq}_{ₙ}≡Iₙ+j·Qₙ allows rewriting of equation (16) as,

$${s}_{{n}^{*}} = \frac{2}{Δ t} \cdot \frac{( {I}_{n} - {I}_{n - 1} ) + j \cdot ( {Q}_{n} - {Q}_{n - 1} )}{( {I}_{n} + {I}_{n - 1} ) + j \cdot ( {Q}_{n} + {Q}_{n - 1} )} \\ \begin{matrix}⇒ {s}_{{n}^{*}} = \frac{2}{Δ t} \cdot \frac{( {I}_{n} - {I}_{n - 1} ) + j \cdot ( {Q}_{n} - {Q}_{n - 1} )}{( {I}_{n} + {I}_{n - 1} ) + j \cdot ( {Q}_{n} + {Q}_{n - 1} )} \cdot \\ \frac{( {I}_{n} + {I}_{n - 1} ) - j \cdot ( {Q}_{n} + {Q}_{n - 1} )}{( {I}_{n} + {I}_{n - 1} ) - j \cdot ( {Q}_{n} + {Q}_{n - 1} )}\end{matrix} \\ ⇒ {s}_{{n}^{*}} = \frac{2}{Δ t} \cdot [ \begin{matrix}\frac{\begin{matrix}( {I}_{n} - {I}_{n - 1} ) \cdot ( {I}_{n} + {I}_{n - 1} ) + \\ ( {Q}_{n} - {Q}_{n - 1} ) \cdot ( {Q}_{n} + {Q}_{n - 1} )\end{matrix}}{{( {I}_{n} + {I}_{n - 1} )}^{2} + {( {Q}_{n} + {Q}_{n - 1} )}^{2}} + \\ j \cdot \frac{\begin{matrix}( {I}_{n} + {I}_{n - 1} ) \cdot ( {Q}_{n} - {Q}_{n - 1} ) - \\ ( {I}_{n} - {I}_{n - 1} ) \cdot ( {Q}_{n} + {Q}_{n - 1} )\end{matrix}}{{( {I}_{n} + {I}_{n - 1} )}^{2} + {( {Q}_{n} + {Q}_{n - 1} )}^{2}}\end{matrix} ] \qquad ( 15 )$$

Equation (15) can be further simplified to produce

$${s}_{{n}^{*}} ≡ \frac{2}{Δ t} \cdot [ \begin{matrix}\frac{( {I}_{n}^{2} + {Q}_{n}^{2} ) - ( {I}_{n - 1}^{2} + {Q}_{n - 1}^{2} )}{{( {I}_{n} + {I}_{n - 1} )}^{2} + {( {Q}_{n} + {Q}_{n - 1} )}^{2}} + \\ j \cdot 2 \cdot \frac{{I}_{n - 1} \cdot {Q}_{n} - {I}_{n} \cdot {Q}_{n - 1}}{{( {I}_{n} + {I}_{n - 1} )}^{2} + {( {Q}_{n} + {Q}_{n - 1} )}^{2}}\end{matrix} ] \qquad ( 16 )$$

Consequently,

$${σ}_{{n}^{*}} = \frac{2}{Δ t} \cdot \frac{( {I}_{n}^{2} + {Q}_{n}^{2} ) - ( {I}_{n - 1}^{2} + {Q}_{n - 1}^{2} )}{{( {I}_{n} + {I}_{n - 1} )}^{2} + {( {Q}_{n} + {Q}_{n - 1} )}^{2}} \\ and \\ {ω}_{{n}^{*}} = \frac{4}{Δ t} \cdot \frac{{I}_{n - 1} \cdot {Q}_{n} - {I}_{n} \cdot {Q}_{n - 1}}{{( {I}_{n} + {I}_{n - 1} )}^{2} + {( {Q}_{n} + {Q}_{n - 1} )}^{2}} \qquad ( 17 )$$

Equation (17) demonstrates how to demodulate a discrete time sampled Complex Frequency Modulated signal and recover both real and imaginary components from its Complex Baseband representation. Recall that ω{t} is the instantaneous frequency deviation from the carrier frequency and σ{t} is a form of non-linear amplitude modulation. The division however is unattractive but for FM and FSK signals the denominator will be relatively constant with modulation. The division can be converted into a multiplication with a simple approximation procedure.

The real component σₙ* is of the form

$${σ}_{{n}^{*}} = \frac{{r}_{n}^{2} - {r}_{n - 1}^{2}}{{r}_{{n}^{*}}^{2}}$$

where rₙ*² refers to an average power and the numerator refers to a difference in power. Consequently σₙ* is a simple ratio between the power difference between samples and average power.

There are many ways to estimate frequency offsets (e.g. FM demodulation) from I and Q signals. One way is to derive phase from the arctangent of Q/I and then differentiate to obtain frequency. However this approach requires some fiddling about with the arctangent function (only valid on ±π/2) An easier way is to begin with a continuous complex valued non-linear mapping described as

$$ω \{ t \} = Im \{ \frac{{\dot{V}}_{iq} \{ t \}}{{V}_{iq} \{ t \}} \} \qquad ( 18 )$$

and convert to a discrete time (sampled) complex valued approximation defined previously,

$${Δω}_{{n}^{*}} ≡ \frac{2}{Δ t} \cdot Im \{ \frac{{V}_{{iq}_{n}} - {V}_{{iq}_{n - 1}}}{{V}_{{iq}_{n}} - {V}_{{iq}_{n - 1}}} \} \qquad ( 19 )$$

with nε[0 . . . N] (i.e. N+1 samples per frequency offset cycle). The Δω “delta” has been added just to emphasis its meaning as frequency offset from carrier. FM demodulation errors associated with this discrete time approximation can now be analysed and compensated for more easily than those associated with previous FM demodulator using the phase from the arctangent of Q and I.

Starting from equation (4) whereby

$$s \{ t \} ≡ \frac{\dot{v \{ t \}}}{v \{ t \}}$$

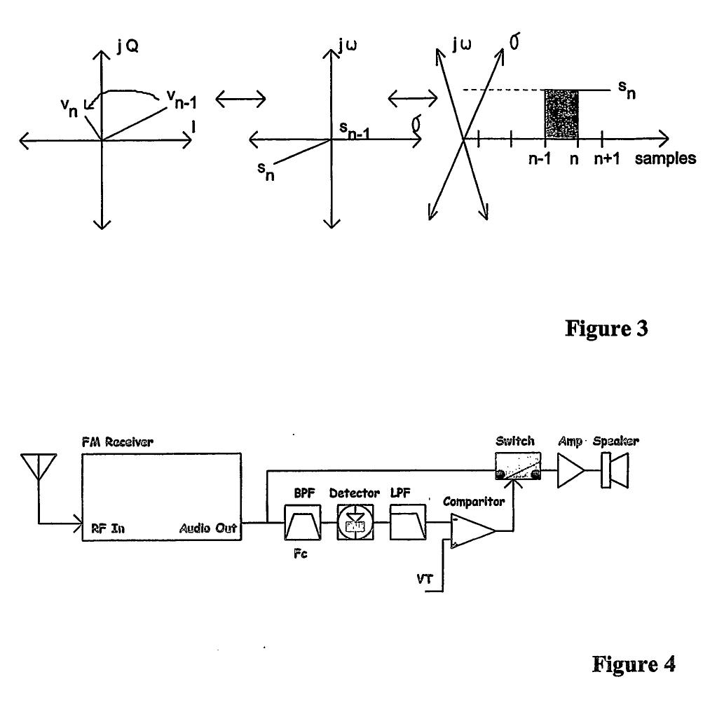

and converting to a discrete time approximation given by

$${ΔΨ}_{{n}^{*}} ≡ \frac{2}{Δ t} \cdot \frac{{v}_{n} - {v}_{n - 1}}{{v}_{n} + {v}_{n - 1}} \qquad ( 20 )$$

where ΔΨₙ* represents the discrete time estimate for sₙ* at an intermediate sample n*. We wish to determine the relationship between this discrete time estimate ΔΨₙ* and the true value sₙ* that we have hypothetically applied. To do this, first imagine that a step complex frequency offset s is applied, starting from s′=0 at sample n−1. Immediately after sample n−1 a step value of s is be applied. This remains constant from sample n−1 up to the n-th sample as shown in FIG. 3.

The previous value of s at the n−1 sample is unnecessary because s is calculated between adjacent sample pairs and has no history wrt previous samples. However, the associated Complex Baseband voltage v may be important, so this starting point will be included. Expressed in equation form,

$${v}_{n - 1} = z \cdot {ⅇ}^{{\int }_{t = - Δ t}^{t = 0} 0 \partial τ } \\ {v}_{n} = z \cdot {ⅇ}^{{\int }_{t = 0}^{Δ t} s \cdot Δ t \partial τσ } \qquad ( 21 )$$

for some arbitrary starting point z

Since s is constant between the n−1 and n-th sample, the integrals simplify,
vₙ₋₁=z
vₙ=z·e^{s}^{_{n*}}^{·Δt} (22)

Using these values in equation (20) implies

$${Δψ}_{{n}^{*}} = \frac{2}{Δ t} \cdot \frac{z \cdot {ⅇ}^{{s}_{{n}^{*}} \cdot Δ t} - z}{z \cdot {ⅇ}^{{s}_{{n}^{*}} \cdot Δ t} + z} \\ i . e . \\ {Δψ}_{{n}^{*}} = \frac{2}{Δ t} \cdot \frac{{ⅇ}^{{s}_{{n}^{*}} \cdot Δ t} - 1}{{ⅇ}^{{s}_{{n}^{*}} \cdot Δ t} + 1} \qquad ( 23 )$$

Equation (23) now expresses the estimated discrete time complex frequency offset ΔΨₙ* based on a known step change in complex frequency sₙ*. Applying some algebra to make sₙ* (the actual modulation) the subject and Ψₙ* (the estimated modulation) the variable produces,

$${s}_{{n}^{*}} = \frac{1}{Δ t} \cdot ln \{ \frac{1 + {ΔΨ}_{{n}^{*}} \cdot \frac{Δ t}{2}}{1 - {ΔΨ}_{{n}^{*}} \cdot \frac{Δ t}{2}} \} \qquad ( 24 )$$

Although equation (24) could be used to correct errors in the estimated complex frequency offset ΔΨₙ* it is somewhat difficult to process within a digital environment. A simpler equation with an equivalent form is needed. To do this, equation (24) is first rewritten with z≡ΔΨₙ* ·Δt/2 (where z is just a dummy variable for now, and is different from the previous scale factor z)

$${s}_{{n}^{*}} = \frac{1}{Δ t} \cdot ln \{ \frac{1 + z}{1 - z} \} \\ where \\ z ≡ {ΔΨ}_{{n}^{*}} \cdot \frac{Δ t}{2} \qquad ( 25 )$$

The corrected solution for sₙ* can also be rewritten as

$${s}_{{n}^{*}} = \frac{1}{Δ t} \cdot ( {log}_{e} \{ 1 + z \} - {log}_{e} \{ 1 - z \} ) \qquad ( 26 )$$

which has a Taylor series expansion of

$${s}_{{n}^{*}} ≅ \frac{1}{Δ t} \cdot ( {\sum }_{k = 1}^{N} {( - 1 )}^{k + 1} \cdot \frac{1}{k} \cdot {z}^{k} - {\sum }_{k = 1}^{N} {( - 1 )}^{k + 1} \cdot \frac{1}{k} \cdot {( - z )}^{k} ) = \frac{1}{Δ t} \cdot {\sum }_{k = 1}^{N} {( - 1 )}^{k + 1} \cdot \frac{1}{k} \cdot ( 1 - {( - 1 )}^{k} ) \cdot {z}^{k} given \vert z \vert < 1 \qquad ( 27 )$$

Note that

$$1 - {( - 1 )}^{k} = \{ \begin{matrix}0 for k even \\ 2 for k odd\end{matrix} .$$

Equation (27) now becomes

$${s}_{{n}^{*}} ≅ \frac{1}{Δ t} \cdot {\sum }_{k = 1}^{N} [ 1 - {( - 1 )}^{k + 1} ] \cdot \frac{1}{k} \cdot {z}^{k} . \qquad ( 28 )$$

Expressed term by term

$${s}_{{n}^{*}} ≅ \frac{2}{Δ t} \cdot ( z + \frac{1}{3} \cdot {z}^{3} + \frac{1}{5} \cdot {z}^{5} + \frac{1}{7} \cdot {z}^{7} + … ) given \vert z \vert < 1 \qquad ( 29 )$$

Previously the dummy variable z was expressed as

$$z ≡ {ΔΨ}_{{n}^{*}} \cdot \frac{Δ t}{2}$$

and recall equation (20) which defined

$${ΔΨ}_{{n}^{*}} ≡ \frac{2}{Δ t} \cdot \frac{{v}_{n} - {v}_{n - 1}}{{v}_{n} + {v}_{n - 1}} .$$

This then implies that z is just,

$$z ≡ \frac{{v}_{n} - {v}_{n - 1}}{{v}_{n} + {v}_{n - 1}} \qquad ( 30 )$$

Equation (30) now allows exact correction of errors caused by discrete time sampling effects,

$${s}_{{n}^{*}} ≅ \frac{2}{Δ t} \cdot ( {z}_{{n}^{*}} + \frac{1}{3} \cdot {z}_{{n}^{*}}^{3} + \frac{1}{5} \cdot {z}_{{n}^{*}}^{5} + \frac{1}{7} \cdot {z}_{{n}^{*}}^{7} + … ) \\ where \\ {z}_{{n}^{*}} ≡ \frac{{v}_{n} - {v}_{n - 1}}{{v}_{n} + {v}_{n - 1}} \qquad ( 35 )$$

providing that |zₙ*|<1 and is in a form that can be processed relatively easy with DSP devices. Equation (31) now allows error free complex frequency offset estimation for both real and imaginary components of Complex Frequency, despite the distortion products that would otherwise result from the discrete time approximations. This has the effect of making both real and imaginary axis “orthogonal” so that σₙ* and ωₙ* remain as two independent signals belonging to sₙ*≡σₙ*+j·ωₙ*. The above equations show that errors caused by discrete time sampling do not affect the accuracy of the frequency offset estimation.

Consider a case where the imaginary component of s is zero, i.e. to produce a logarithmic form of AM.

$${Ω}_{{n}^{*}} ≡ Re \{ \frac{{v}_{n} - {v}_{n - 1}}{{v}_{n} + {v}_{n - 1}} \} \qquad ( 32 )$$

This allows equation (31) to be rewritten as

$${s}_{{n}^{*}} ≅ \frac{2}{Δ t} \cdot ( {Ω}_{{n}^{*}} + \frac{1}{3} \cdot {Ω}_{{n}^{*}}^{3} + \frac{1}{5} \cdot {Ω}_{{n}^{*}}^{5} + \frac{1}{7} \cdot {Ω}_{{n}^{*}}^{7} + … ) \\ where {Ω}_{{n}^{*}} ≡ Re \{ \frac{{v}_{n} - {v}_{n - 1}}{{v}_{n} + {v}_{n - 1}} \} \qquad ( 33 )$$

providing that |Ωₙ*|<1

Although conventional systems do not make active use of the real component, communication systems can be built that use this axis, and in such a hypothetical case, equation (33) could be used to compensate for discrete time sampled errors.

The above equations describe a Non Linear transform that maps a complex baseband signal V_{iq}{t} to a complex frequency offset interpretation s{t}. In this representation, the real component of s{t} represents an amplitude variation, and the imaginary component refers to a frequency offset. As a result, conventional FM demodulation algorithms, e.g. differential of arctan of Q/I are a sub set of this transform.

The Non Linear Transform is bi-directional, i.e. is used for both modulation and demodulation. These transforms have been expressed in both complex and real variable. However the transform may also need to be used in discrete time sampled applications, which typically leads to non-linear demodulation. A method for exact error compensation presented in equation (31) in complex variables.

The Non Linear Transform when combined with its polynomial compensation algorithm produces arbitrary accuracy and can be used for FM demodulation despite having a finite, but bounded sample rate.

The advantage of the approach described above is that the minimum sample rate can be used in a DSP based implementation, reducing cost. In addition, high fidelity applications, such as broadcast FM that require ultra low distortion, would benefit Although the use of equation (31) is optimal, there may be cases where discarding one component is allowable. The correction polynomial has been described in complex variables. This is probably an optimum method as finite discrete time sampling causes an intermingling of real and imaginary complex frequency components. Now assume a simplified demodulation is used based only on real variables. Providing only one of the modulation axes is used, correction is still possible. However the presence of noise exists in both real and imaginary components, and a simpler demodulation approach might be affected more by this.

Starting from equation (5) whereby

$$σ \{ t \} ≡ \frac{\dot{r \{ t \}}}{r \{ t \}}$$

and converting to a discrete time approximation given by

$${ΔΓ}_{{n}^{*}} ≡ \frac{2}{Δ t} \cdot \frac{{r}_{n} - {r}_{n - 1}}{{r}_{n} + {r}_{n - 1}} \qquad ( 34 )$$

Here ΔΓₙ* represents the discrete time estimate for σₙ* at an intermediate sample n*. A fixed real frequency offset σ will be applied, starting from σ′=0 at the (n−1)^{th} sample. Immediately after a fixed value of σ will be applied to the n^{th} sample, i.e.

$${r}_{n - 1} = {ⅇ}^{{\int }_{t = - Δ t}^{t = 0} 0 \partial τ} \\ {r}_{n} = {ⅇ}^{{\int }_{t = 0}^{Δ t} σ \cdot Δ t \partial τσ} \qquad ( 35 )$$

Since σ is constant between the n−1 and n-th sample, the integrals magnitudes r become,
rₙ₋₁=1
rₙ=e^{σ}^{_{n*}}^{·Δt} (36)

Using these values in equation (34) implies

$${ΔΓ}_{{n}^{*}} = \frac{2}{Δ t} \cdot \frac{{ⅇ}^{{σ}_{{n}^{*}} \cdot Δ t} - 1}{{ⅇ}^{{σ}_{{n}^{*}} \cdot Δ t} + 1} \qquad ( 37 )$$

Applying some algebra to make sigma (the actual modulation) the subject and Gamma (the estimated modulation) the variable produces,

$${σ}_{{n}^{*}} = \frac{1}{Δ t} \cdot ln \{ \frac{1 + {ΔΓ}_{{n}^{*}} \cdot \frac{Δ t}{2}}{1 - {ΔΓ}_{{n}^{*}} \cdot \frac{Δ t}{2}} \} \qquad ( 38 )$$

The estimated sigma modulation ΔΓₙ* obtained from the discrete time approximation in equation (34) can now be corrected using the compensating formula

$${σ}_{{n}^{*}} = \frac{1}{Δ t} \cdot ln \{ \frac{1 + {ΔΓ}_{{n}^{*}} \cdot \frac{Δ t}{2}}{1 - {ΔΓ}_{{n}^{*}} \cdot \frac{Δ t}{2}} \} .$$

This has a singularity at

$${ΔΓ}_{{n}^{*}} = \frac{2}{Δ t} = 2 \cdot {F}_{S} .$$

A range for ΔΓₙ* can be predicted as

$$- \frac{2}{Δ t} \leq {ΔΓ}_{{n}^{*}} \leq \frac{2}{Δ t} \qquad ( 39 )$$

for any value of σₙ*. Therefore, the finite time-domain sampling does not limit the range of values that σₙ* can take on.

The effect of finite discrete time sampling is to produce a tan(x) based distortion based on the angular variation between samples as given by Δψₙ* =tan {θ_{n-θ}ₙ₋₁}. As found previously, the complex frequency estimate can be corrected with an arctangent function.

As the number of samples is reduced the frequency estimate is increasingly distorted by the tangent of the angular difference between points. The angular difference is

$$Δθ = \frac{2 \cdot π}{N + 1} \qquad ( 41 )$$

For a fixed normalised frequency

$${ΔΩ}_{n} ≡ \frac{1}{N + 1} \\ ⇒ Δθ = 2 \cdot π \cdot {ΔΩ}_{n} \qquad ( 42 )$$

(since the ratio ΔΩₙ represents the number of samples in each offset frequency cycle).

Equation (17) now becomes
Δψₙ=tan {2·π·ΔΩₙ} (43)

Equation (43) gives the relationship between the estimated normalised frequency offset (discrete time) Δψₙ and the actual normalised frequency offset ΔΩₙ. Also note that Δψₙ is constant for all samples n. The actual normalised frequency offset ΔΩₙ and its estimated value ΔΩ′ can be distinguished by first calculating the (distorted) estimate Δψₙ and applying an arctangent correction

$${ΔΩ}_{n}^{′} = \frac{1}{2 \cdot π} \cdot arctan \{ {Δψ}_{n} \} \\ i . e . \\ {ΔΩ}_{n}^{′} = \frac{1}{2 \cdot π} \cdot arctan \{ \frac{{V}_{{i}_{n - 1}} \cdot {V}_{{q}_{n}} - {V}_{{i}_{n}} \cdot {V}_{{q}_{n - 1}}}{{( {V}_{{i}_{n}} + {V}_{{i}_{n - 1}} )}^{2} + ( {V}_{{q}_{n}} + {V}_{{q}_{n - 1}} )} \} \qquad ( 44 )$$

Equation (44) now provides an undistorted estimate of the normalised frequency offset ΔΩₙ. Finally, to obtain the actual corrected frequency offset estimate equation (44) is scaled by the sample frequency

$$Δ {f}_{n}^{′} = \frac{{F}_{s}}{2 \cdot π} \cdot arctan \{ \frac{{V}_{{i}_{n - 1}} \cdot {V}_{{q}_{n}} - {V}_{{i}_{n}} \cdot {V}_{{q}_{n - 1}}}{{( {V}_{{i}_{n}} + {V}_{{i}_{n - 1}} )}^{2} + {( {V}_{{q}_{n}} + {V}_{{q}_{n - 1}} )}^{2}} \} \qquad ( 45 )$$

If the frequency offset is small compared to the sample frequency (e.g. less than 1/20 Fs) then the arctangent correction may not be needed. However a practical limit for correction will be in the order of ¼ the sample frequency or less.

The arctangent can be implemented as either a polynomial or look up table or combination of both. Equation (45) now represents a relatively simple and computationally efficient discrete time demodulation algorithm given that the denominator division is approached as per equation (17).

FIG. 4 shows a conventional analog FM receiver. Conventional Analog FM receivers incorporate a SINAD estimation circuit (or process) that quiets the receiver output when the RF input signal falls below a given threshold. This extra processing eliminates unwanted audio hiss that would otherwise be present. The standard mute implementation involves the use of a band pass filter, centered above the audio frequency range, followed by a simple amplitude measuring circuit. Since a FM receiver “quiets” when a signal is present, measuring this noise power can be used to determine whether the demodulated signal should be passed on to the listener.

The band pass filter of the receiver is typically centered at ½ the receivers demodulation bandwidth, which is where its output noise power is highest. Speech energy should be low in this region, but can cause “mute desensing” on voice messages. The effect of this energy is to cause unwanted voice muting, especially on highly modulated signals. Distortion products can also fall in the noise pass-band, especially in cases where a frequency offset exists.

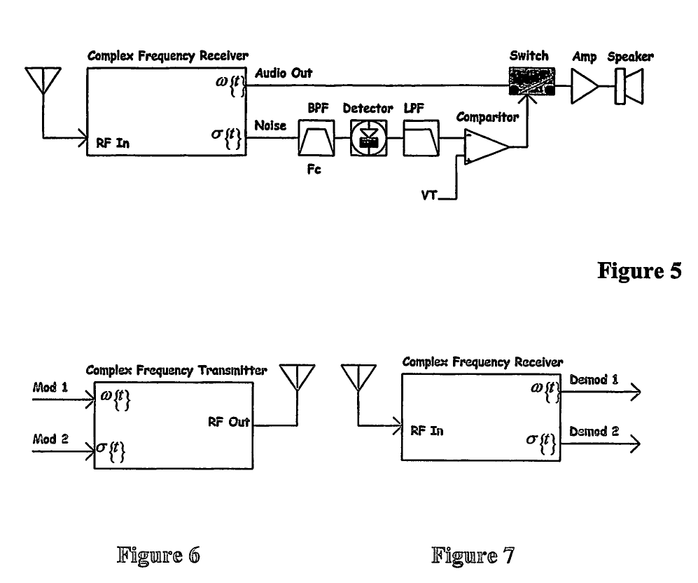

Complex frequency demodulation can be used to improve this situation. FIG. 5 shows an FM receiver incorporating the frequency offset estimation of the invention. In this representation the demodulated signal contains real and imaginary components
s{t}=σ{t}+j·ω{t}
where s{t}, σ{t} and ω{t} have been defined previously (see for example equations 4 and 9 above).

The wanted FM demodulated signal ω{t} is switched based on the noise power contained in the σ{t} component. This noise power is equivalent to the noise associated with ω{t} but lacks the demodulated signal. Consequently, the danger of “mute desensing” is reduced.

In this approach the BPF, Detector, LPF, comparator and switch would be implemented digitally, in any suitable device.

The real component of s{t} can also be used to send additional information, without affecting a standard FM receiver from operating. FIG. 6 shows a complex frequency transmitter incorporating frequency offset estimation of the invention.

In principle, the spectral efficiency can be increased by a factor of two, simply by adding the real component σ{t}. This has the effect of adding amplitude modulation to the carrier, which is ignored by a conventional FM or FSK receiver.

Also, the need for absolute phase accuracy, as in the case of QAM is avoided. The process of differentiating Viq{t} and dividing by itself removes the need for absolute phase and amplitude estimation, which simplifies the demodulation of fast fading signals. FIG. 7 shows a complex frequency receiver that produces two signal using the complex frequency estimator of FIGS. 1 and 2. A corrected frequency offset estimation could also be applied in accordance with equation 45. The frequency offset estimator of the complex frequency receiver as illustrated in FIG. 7 could be implemented in software or hardware or a combination of software or hardware. The software and/or hardware for implementing the frequency offset estimator could be a DSP, microprocessor, FPGA or any other suitable hardware. In preferred embodiments the software/hardware is arranged to determine a plurality of frequency offset estimates for the signal at a plurality of instants of time. Mathematically equivalent or alternative forms of the frequency estimation equation including the corrected frequency estimation equation could also be implemented in hardware.

The foregoing describes the invention including preferred forms thereof. Alterations and modifications as will be obvious to those skilled in the art are intended to be incorporated in the scope hereof as defined by the accompanying claims.

1-41. (canceled)

42. A method for estimating the frequency offset of a signal comprising:
obtaining samples of the signal at at least two instants in time, and
utilising the samples in a mathematical equation relating the estimated offset frequency to the samples,
wherein the mathematical equation is derived based on the premise of a modulating signal with a complex frequency.

43. A method for estimating the frequency offset of a signal as claimed in claim 42 wherein the mathematical equation includes a numerator that provides FM demodulation.

44. A method for estimating the frequency offset of a signal as claimed in claim 1 wherein the mathematical equation includes a denominator that provides scaling.

45. A method for estimating the frequency offset of a signal as claimed in claim 42 wherein a sampler samples the signal to obtain I and Q component samples of the signal at at least two instants in time.

46. A method for estimating the frequency offset of a signal as claimed in claim 45 wherein the estimated frequency offset is obtained from the samples using the relationship
$${ω}_{{n}^{*}} = \frac{2}{Δ t} \cdot \frac{{I}_{n - 1} \cdot {Q}_{n} - {I}_{n} \cdot {Q}_{n - 1}}{{( {I}_{n} + {I}_{n - 1} )}^{2} + {( {Q}_{n} + {Q}_{n - 1} )}^{2}}$$
where ωₙ* is the frequency offset, Iₙ₋₁, Iₙ and Qₙ₋₁, Qₙ are I and Q samples at respective instants in time, n is the sample number and Δt is the sample interval.

47. A method for estimating the frequency offset of a signal as claimed in claim 45 where a mathematical equivalent of the relationship
$${ω}_{{n}^{*}} = \frac{2}{Δ t} \cdot \frac{{I}_{n - 1} \cdot {Q}_{n} - {I}_{n} \cdot {Q}_{n - 1}}{{( {I}_{n} + {I}_{n - 1} )}^{2} + {( {Q}_{n} + {Q}_{n - 1} )}^{2}}$$
is used to determine the frequency offset.

48. A method for estimating the frequency offset of a signal as claimed in claim 46 wherein a correction is applied to the relationship to produce
$$Δ {f}_{n}^{′} = \frac{{F}_{s}}{2 \cdot π} \cdot arctan \{ \frac{{V}_{{i}_{n - 1}} \cdot {V}_{{q}_{n}} - {V}_{{i}_{n}} \cdot {V}_{{q}_{n - 1}}}{{( {V}_{{i}_{n}} + {V}_{{i}_{n - 1}} )}^{2} + {( {V}_{{q}_{n}} + {V}_{{q}_{n - 1}} )}^{2}} \}$$
where Δf′ₙ is the corrected estimate of frequency offset ωₙ* and Fₛ is 1/Δt.

49. A method for estimating the frequency offset of a signal as claimed in claim 47 wherein a correction is applied to the relationship to produce
$$Δ {f}_{n}^{′} = \frac{{F}_{s}}{2 \cdot π} \cdot arctan \{ \frac{{V}_{{i}_{n - 1}} \cdot {V}_{{q}_{n}} - {V}_{{i}_{n}} \cdot {V}_{{q}_{n - 1}}}{{( {V}_{{i}_{n}} + {V}_{{i}_{n - 1}} )}^{2} + {( {V}_{{q}_{n}} + {V}_{{q}_{n - 1}} )}^{2}} \}$$
where Δf′ₙ is the corrected estimate of frequency offset ωₙ* and Fₛ is 1/Δt.

50. A method for estimating the frequency offset of a signal as claimed in claim 42 further comprising estimating the frequency offset for the signal at a plurality of instants in time.

51. A method for estimating the frequency offset of a signal as claimed in claim 45 wherein the I and Q component samples utilised in the mathematical relationship are samples adjacent in time.

52. A method for demodulating an FM signal comprising using the method of estimating the frequency offset of a signal as claimed in claim 42.

53. A method of modulating an FM signal comprising using the method of estimating the frequency offset of a signal as claimed in claim 42.

54. Hardware for estimating the frequency offset of a signal comprising,
a sampler for obtaining samples of a signal at at least two instants in time, and
a processor for implementing a mathematical equation for obtaining an offset frequency from the samples,
wherein the mathematical equation is derived based on the premise of a modulating signal with complex frequency.

55. Hardware for estimating the frequency offset of a signal as claimed in claim 54 wherein the mathematical equation has a numerator that provides FM demodulation.

56. Hardware for estimating the frequency offset of a signal as claimed in claim 54 wherein the mathematical equation has a denominator that provides scaling.

57. Hardware for estimating the frequency offset of a signal as claimed in claim 54 wherein the sampler obtains I and Q component samples representing the signal at at least two instants in time.

58. Hardware for estimating the frequency offset of a signal as claimed in claim 57 wherein the processor determines the frequency offset from the samples utilising a relationship
$${ω}_{{n}^{*}} = \frac{2}{Δ t} \cdot \frac{{I}_{n - 1} \cdot {Q}_{n} - {I}_{n} \cdot {Q}_{n - 1}}{{( {I}_{n} + {I}_{n - 1} )}^{2} + {( {Q}_{n} + {Q}_{n - 1} )}^{2}}$$
where ωₙ* is the frequency offset, Iₙ₋₁, Iₙ and Qₙ₋₁, Qₙ are I and Q samples at respective instants in time, n is the sample number and Δt is the sample interval.

59. Hardware for estimating the frequency offset of a signal as claimed in claim 57 wherein the processor determines the frequency offset from an approximation or mathematical equivalent of the relationship
$${ω}_{{n}^{*}} = \frac{2}{Δ t} \cdot \frac{{I}_{n - 1} \cdot {Q}_{n} - {I}_{n} \cdot {Q}_{n - 1}}{{( {I}_{n} + {I}_{n - 1} )}^{2} + {( {Q}_{n} + {Q}_{n - 1} )}^{2}} .$$

60. Hardware for estimating the frequency offset of a signal as claimed in claim 58 wherein the processor applies a correction to the frequency offset using the relationship
$$Δ {f}_{n}^{′} = \frac{{F}_{s}}{2 \cdot π} \cdot arctan \{ \frac{{V}_{{i}_{n - 1}} \cdot {V}_{{q}_{n}} - {V}_{{i}_{n}} \cdot {V}_{{q}_{n - 1}}}{{( {V}_{{i}_{n}} + {V}_{{i}_{n - 1}} )}^{2} + {( {V}_{{q}_{n}} + {V}_{{q}_{n - 1}} )}^{2}} \}$$
where Δf′ₙ is the corrected estimate of frequency offset ωₙ* and Fₛ is 1/Δt.

61. Hardware for estimating the frequency offset of a signal as claimed in claim 59 wherein the processor applies a correction to the frequency offset using the relationship
$$Δ {f}_{n}^{′} = \frac{{F}_{s}}{2 \cdot π} \cdot arctan \{ \frac{{V}_{{i}_{n - 1}} \cdot {V}_{{q}_{n}} - {V}_{{i}_{n}} \cdot {V}_{{q}_{n - 1}}}{{( {V}_{{i}_{n}} + {V}_{{i}_{n - 1}} )}^{2} + {( {V}_{{q}_{n}} + {V}_{{q}_{n - 1}} )}^{2}} \}$$
where Δf′ₙ is the corrected estimate of frequency offset ωₙ* and Fₛ is 1/Δt.

62. Hardware for estimating the frequency offset of a signal as claimed in claim 57 wherein the I and Q component samples used in the relationship are adjacent in time.

63. A device for demodulating an FM signal including hardware as claimed in claim 54.

64. A device for modulating an FM signal including hardware as claimed in claim 54.

65. A frequency control loop for use in an FM modulator or demodulator comprising:
hardware for mixing signals from a frequency source and a voltage controlled oscillator,
a processor for implementing a frequency offset estimation method as claimed in claim 1, and
an integrator for generating an error control signal for the voltage controlled oscillator.

66. A method of muting an FM signal comprising:
obtaining samples of the signal at at least two instants of time,
utilising the samples in a mathematical equation relating to the estimated offset frequency of the samples to demodulate the FM signal,
wherein the mathematical equation is derived based on the premise of the modulating signal with complex frequency, and
using the real component of the demodulated signal for mute sensing.

67. A method of muting an FM signal as claimed in claim 66 wherein the mathematical equation includes a numerator that provides FM demodulation.

68. A method of muting an FM signal as claimed in claim 66 wherein the mathematical equation includes a denominator that provides scaling.

69. A method of muting an FM signal as claimed in claim 66 wherein the sampler samples the signal to obtain I and Q component samples of the signal at at least two instants in time.

70. A method of muting an FM signal as claimed in claim 69 wherein the real component of the demodulated signal is obtained from the samples using the relationship
$${σ}_{{n}^{*}} = \frac{2}{Δ t} \cdot \frac{( {I}_{n}^{2} + {Q}_{n}^{2} ) - ( {I}_{n - 1}^{2} + {Q}_{n - 1}^{2} )}{{( {I}_{n} + {I}_{n - 1} )}^{2} + {( {Q}_{n} + {Q}_{n - 1} )}^{2}}$$
where σₙ* is a form of non-linear amplitude modulation, Iₙ₋₁, Iₙ, Qₙ₋₁, Qₙ are I and Q samples at respective instants of time, n is the sample number and Δt is the sample interval.

71. A method of muting an FM signal as claimed in claim 69 wherein a mathematical equivalent of the relationship
$${σ}_{{n}^{*}} = \frac{2}{Δ t} \cdot \frac{( {I}_{n}^{2} + {Q}_{n}^{2} ) - ( {I}_{n - 1}^{2} + {Q}_{n - 1}^{2} )}{{( {I}_{n} + {I}_{n - 1} )}^{2} + {( {Q}_{n} + {Q}_{n - 1} )}^{2}}$$
is used for muting.

72. A method of muting an FM signal as claimed in claim 66 further including determining the real component of the demodulated signal for the signal at a plurality of instants of time.

73. A method of muting an FM signal as claimed in claim 69 wherein the I and Q component samples utilised in the mathematical relationship are samples adjacent in time.

74. An FM receiver comprising,
a sampler for obtaining samples of a signal at at least two instants of time,
a processor for implementing a mathematical equation that demodulates the samples into real and imaginary parts, and
wherein the mathematical equation is derived based on the premise of a modulating signal with complex frequency.

75. An FM receiver as claimed in claim 74 wherein the mathematical equation has a numerator that provides FM demodulation.

76. An FM receiver as claimed in claim 74 wherein the mathematical equation has a denominator that provides scaling.

77. An FM receiver as claimed in claim 74 wherein the sampler obtains I and Q component samples representing the signal at at least two instants in time.

78. An FM receiver as claimed in claim 77 wherein the processor determines the frequency offset from the samples utilising a relationship
$${σ}_{{n}^{*}} = \frac{2}{Δ t} \cdot \frac{( {I}_{n}^{2} + {Q}_{n}^{2} ) - ( {I}_{n - 1}^{2} + {Q}_{n - 1}^{2} )}{{( {I}_{n} + {I}_{n - 1} )}^{2} + {( {Q}_{n} + {Q}_{n - 1} )}^{2}}$$
where σₙ* is a form of non-linear amplitude modulation, Iₙ₋₁, Iₙ and Qₙ₋₁, a Qₙ are I and Q samples at respective instants in time, n is the sample number and Δt is the sample interval.

79. An FM receiver as claimed in claim 78 wherein the processor determines the frequency offset from an approximation or mathematical equivalent of the relationship
$${σ}_{{n}^{*}} = \frac{2}{Δ t} \cdot \frac{( {I}_{n}^{2} + {Q}_{n}^{2} ) - ( {I}_{n - 1}^{2} + {Q}_{n - 1}^{2} )}{{( {I}_{n} + {I}_{n - 1} )}^{2} + {( {Q}_{n} + {Q}_{n - 1} )}^{2}} .$$

80. An FM receiver as claimed in claim 77 wherein the I and Q component samples used in the relationship are adjacent in time.

81. An FM receiver as claimed in claim 74 further comprising:
a bandpass filter that filters the real part of the demodulated signal from the processor,
a detector,
a low pass filter,
a comparator, and
a switch to switch audio on and off depending on the output of the comparator.
